(19) United States
(12) Patent Application Publication
(10) Pub. No.: US 2025/0222968 A1
(43) Pub. Date: Jul. 10, 2025

(54) BOTTOM DOUBLE-CROSS TRAILER

(71) Applicant: Wuyi County Haiqiu Technology Co., Ltd., Jinhua (CN)

(72) Inventor: QINGYUAN WU, Bozhou (CN)

(21) Appl. No.: 18/940,142

(22) Filed: Nov. 7, 2024

(30) Foreign Application Priority Data
Jan. 8, 2024 (CN) 202410022868.5

(51) Int. Cl. B62B 3/02

(52) U.S. Cl. CPC B62B 3/02

(57) ABSTRACT

This application relates to folding trailers, specifically a bottom double-cross trailer. It has two first and two second vertical poles. Left and right support rods are between the two first vertical poles, and front and rear support rods are between the first and second vertical poles. A hanging rod is in the middle of the front and rear support rod group, with symmetrical left and right bottom cross rod groups on each side. The left bottom cross rod group connects to the first vertical pole, and the right to the second. The hanging rod's bottom is fixed to a base support piece. The left and right bottom cross rod groups connect via the hanging rod, and their attachment points to the base support piece rotate. The hanging rod provides upward tension to prevent collapse under load, enhancing load-bearing capacity.

### CROSS-REFERENCE TO RELATED APPLICATIONS

This application claims priority to Chinese Patent Application No. 202410022868.5, filed on Jan. 8, 2024, which is hereby incorporated by reference in its entirety.

### TECHNICAL FIELD

This application pertains to the field of folding trailers and specifically concerns a type of bottom double-cross trailer.

### BACKGROUND

Trailers, moved by human force through pushing and pulling, come in various structures tailored to different purposes. General-purpose trailers usually have a cargo platform, while specialized trailers have more complex structures. Some trailers have box-shaped bodies suitable for carrying lightweight items that are easy to load and unload; others feature extended brackets to accommodate rods, shafts, tubes, and other components; some are shaped precisely to fit the cargo; others are compact and foldable for easy transportation; and some have two flat steel bars on the body forming a low, sloped surface to facilitate the loading and unloading of cylindrical items. Modern trailers are equipped with rolling bearings, and their wheels are either solid or pneumatic tires.

Most current folding trailers are primarily made of multiple metal tubes that intersect, distributed around the sides and the bottom of the trailer. The bottom cross tubes are typically limited to one set, usually consisting of only four tubes, leading to generally low cargo area and weight capacity. To ensure stability, these trailers use hanging rods to connect the bottom cross tubes with the side cross tubes. There are mainly two types of hanging rods: one is made of flexible metal, which, despite its flexibility, cannot achieve a right-angle bend, resulting in significant gaps when folded; the other type is a sliding hanging rod, which has lower structural stability.

The technical problem this application aims to solve is how to increase the cargo space and weight capacity of the bottom part of the trailer.

### SUMMARY

To overcome the shortcomings of existing technology, the objective of this application is to provide a bottom double-cross trailer that is structurally stable, does not increase in height when folded, and has a large cargo space with a strong carrying capacity.

The technical solution adopted in this application is as follows: A bottom double-cross trailer, which includes two first vertical poles and two second vertical poles. Between the two first vertical poles, there is a set of left and right support rods, and between the first and second vertical poles, there is a set of front and rear support rods. In the middle of the front and rear support rod group, there is a hanging rod. On both sides of the hanging rod, there are symmetrically distributed left and right bottom cross rod groups. The left bottom cross rod group is connected to the first vertical pole, while the right bottom cross rod group is connected to the second vertical pole. The bottom of the hanging rod is fixed with a base support piece. The left and right bottom cross rod groups are connected through the hanging rod, and their connection points with the base support piece are designed to rotate.

In some embodiments, each of the first and second vertical poles has an upper fixing sleeve and a lower fixing sleeve fixed at their tops and bottoms, respectively. Each of the first and second vertical poles is also fitted in the middle with a sliding sleeve that slides up and down along their surface.

In some embodiments, the front and rear support rod group includes a first front and rear support rod and a fourth front and rear support rod, both of which rotate in conjunction with the upper fixing sleeve, and a fifth front and rear support rod and a tenth front and rear support rod that rotate in conjunction with the sliding sleeve.

In some embodiments, the front and rear support rod group additionally includes a sixth front and rear support rod that rotates in conjunction with the fifth front and rear support rod, a second front and rear support rod that rotates in conjunction with the sixth front and rear support rod, a seventh front and rear support rod that rotates in conjunction with the first front and rear support rod, a ninth front and rear support rod that rotates in conjunction with the tenth front and rear support rod, a third front and rear support rod that rotates in conjunction with the ninth front and rear support rod, and an eighth front and rear support rod that rotates in conjunction with the fourth front and rear support rod.

In some embodiments, the hanging rod is simultaneously connected at the junctions of the second front and rear support rod and the third front and rear support rod with the junctions of the seventh front and rear support rod and the eighth front and rear support rod.

In some embodiments, the left and right support rod group includes a first left and right support rod and a second left and right support rod, both of which rotate in conjunction with the upper fixing sleeve. The left and right support rod group also includes a third left and right support rod and a fourth left and right support rod, both of which rotate in conjunction with the sliding sleeve. The first left and right support rod and the second left and right support rod rotate in conjunction, as do the third left and right support rod and the fourth left and right support rod.

In some embodiments, the left bottom cross rod group includes a left first bottom cross rod and a left third bottom cross rod, both of which rotate in conjunction with the lower fixing sleeve. The left bottom cross rod group also includes a left second bottom cross rod and a left fourth bottom cross rod, both of which rotate in conjunction with the base support piece. The left first bottom cross rod, left second bottom cross rod, left third bottom cross rod, and left fourth bottom cross rod form an X-shape. The intersection center of the left first bottom cross rod, left second bottom cross rod, left third bottom cross rod, and left fourth bottom cross rod is equipped with a left center fixing piece that rotates in conjunction with them.

In some embodiments, the right bottom cross rod group includes a right second bottom cross rod and a right fourth bottom cross rod, both of which rotate in conjunction with the lower fixing sleeve. The right bottom cross rod group also includes a right first bottom cross rod and a right third bottom cross rod, both of which rotate in conjunction with the base support piece. The intersection center of the right first bottom cross rod, right second bottom cross rod, right third bottom cross rod, and right fourth bottom cross rod is equipped with a right center fixing piece that rotates in conjunction with them.

The beneficial effects of this application are as follows: The left and right bottom cross rod groups set at the bottom of the trailer increase the bottom carrying area of the trailer, allowing it to carry larger and longer items. Meanwhile, the hanging rod set between the left and right bottom cross rod groups provides upward tension for both cross rod groups, preventing them from collapsing under the weight of the cargo. This increases the load-bearing capacity of the trailer, enabling it to carry heavier items.

### BRIEF DESCRIPTION OF DRAWINGS

FIG. 1 shows a three-dimensional schematic diagram of the application;

FIG. 2 shows a front view schematic diagram of the application;

FIG. 3 shows a right view schematic diagram of the application;

FIG. 4 shows a top view schematic diagram of the application;

FIG. 5 shows one of the schematic diagrams of the application in the folded state;

FIG. 6 shows another schematic diagram of the application in the folded state.

In the diagrams: 1—first vertical pole; 2—second vertical pole; 3—upper fixing sleeve; 4—sliding sleeve; 5—lower fixing sleeve.

6, Front and rear support rod group; 60, First front and rear support rod; 61, Second front and rear support rod; 62, Third front and rear support rod; 63, Fourth front and rear support rod; 64, Fifth front and rear support rod; 65, Sixth front and rear support rod; 66, Seventh front and rear support rod; 67, Eighth front and rear support rod; 68, Ninth front and rear support rod; 69, Tenth front and rear support rod;

7, Left and right support rod group; 70, First left and right support rod; 71, Second left and right support rod; 72, Third left and right support rod; 73, Fourth left and right support rod;

8, Left bottom cross rod group; 80, Left first bottom cross rod; 81, Left second bottom cross rod; 82, Left third bottom cross rod; 83, Left fourth bottom cross rod; 84, Left center fixing piece;

9, Right bottom cross rod group; 90, Right first bottom cross rod; 91, Right second bottom cross rod; 92, Right third bottom cross rod; 93, Right fourth bottom cross rod; 94, Right center fixing piece;

10, Hanging rod; 101, Base support piece.

### DESCRIPTION OF EMBODIMENTS

The following detailed and complete description of the technical solution in the embodiments of this application is provided in conjunction with the accompanying drawings of the embodiments. It is apparent that the described embodiments are only a part of the embodiments of this application, and not all embodiments. Based on the embodiments in this application, all other embodiments obtained by those skilled in the art without creative work fall within the scope of protection of this application.

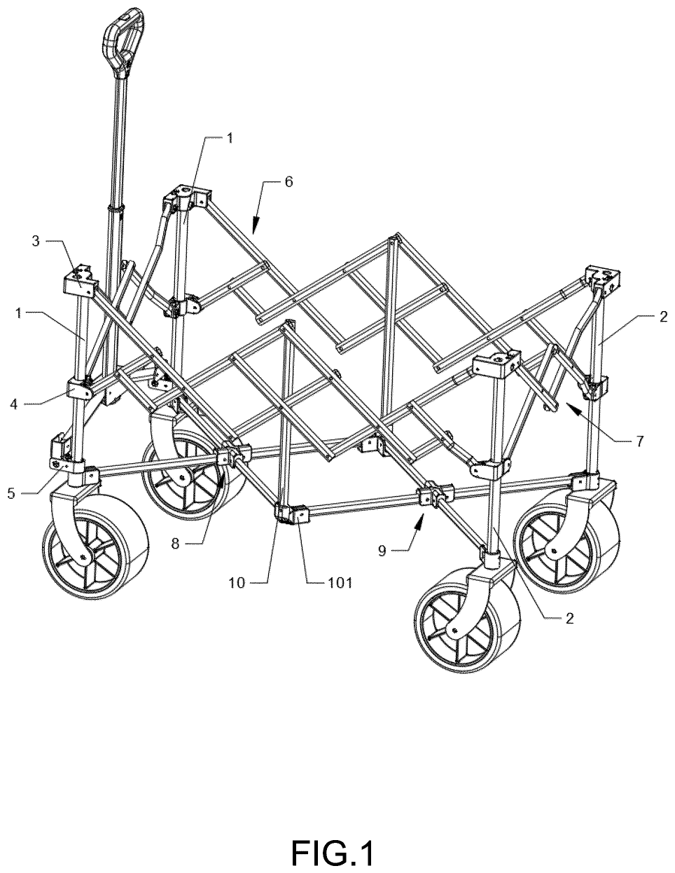

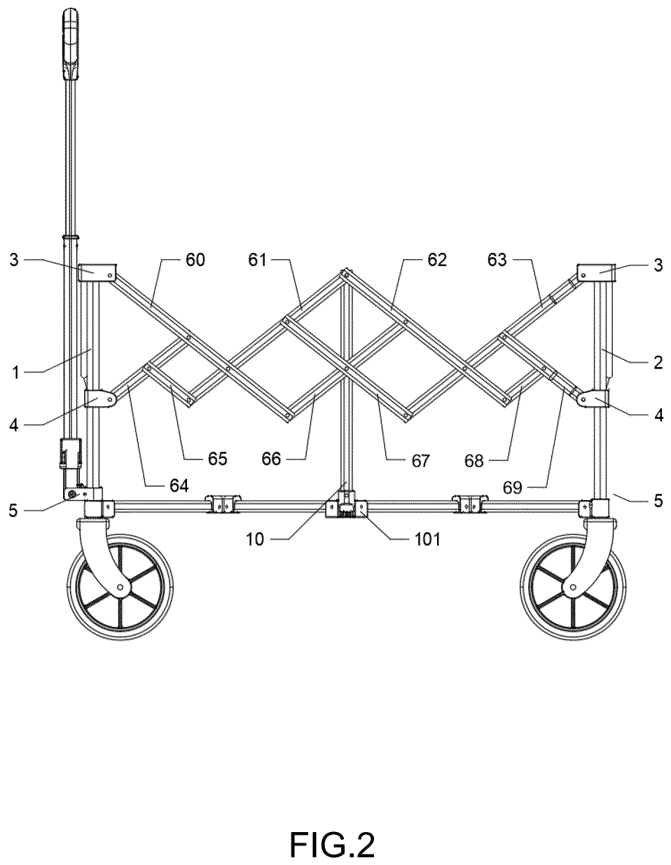

Please refer to FIGS. 1 and 2, this application provides a technical solution for a bottom double-cross trailer. It includes two first vertical poles (1) and two second vertical poles (2). The four vertical poles are set parallel to each other. The top and bottom of each vertical pole are respectively fixed with an upper fixing sleeve (3) and a lower fixing sleeve (5), and each pole is externally fitted with a sliding sleeve (4) that slides up and down along its surface. Between the first vertical pole (1) and the second vertical pole (2), there is a front and rear support rod group (6), which consists of the first front and rear support rod (60), second front and rear support rod (61), third front and rear support rod (62), fourth front and rear support rod (63), fifth front and rear support rod (64), sixth front and rear support rod (65), seventh front and rear support rod (66), eighth front and rear support rod (67), ninth front and rear support rod (68), and tenth front and rear support rod (69).

Among these, the first front and rear support rod (60) is connected inside the upper fixing sleeve (3) at the top of the first vertical pole (1), the fifth front and rear support rod (64) is connected inside the sliding sleeve (4) in the middle of the first vertical pole (1), the fourth front and rear support rod (63) is connected inside the upper fixing sleeve (3) at the top of the second vertical pole (2), and the tenth front and rear support rod (69) is connected inside the sliding sleeve (4) in the middle of the second vertical pole (2). The other end of the fifth front and rear support rod (64) is connected to the middle of the first front and rear support rod (60) through a pivot, and the other end of the tenth front and rear support rod (69) is connected to the middle of the fourth front and rear support rod (63). The middle of the fifth front and rear support rod (64) is connected to the sixth front and rear support rod (65) through a pivot, and the other end of the sixth front and rear support rod (65) is connected to the second front and rear support rod (61) through a pivot. The middle of the second front and rear support rod (61) is also connected to the middle of the first front and rear support rod (60) through a pivot, The other end of the first front and rear support rod (60) is connected to the seventh front and rear support rod (66) through a pivot. Similarly, the middle of the tenth front and rear support rod (69) is connected to the ninth front and rear support rod (68) through a pivot. The other end of the ninth front and rear support rod (68) is connected to the third front and rear support rod (62) through a pivot. The other end of the fourth front and rear support rod (63) is connected to the eighth front and rear support rod (67) through a pivot. The second front and rear support rod (61) and the third front and rear support rod (62) are connected at their other ends through a pivot, and the seventh front and rear support rod (66) and the eighth front and rear support rod (67) are interconnected in a cross-configuration.

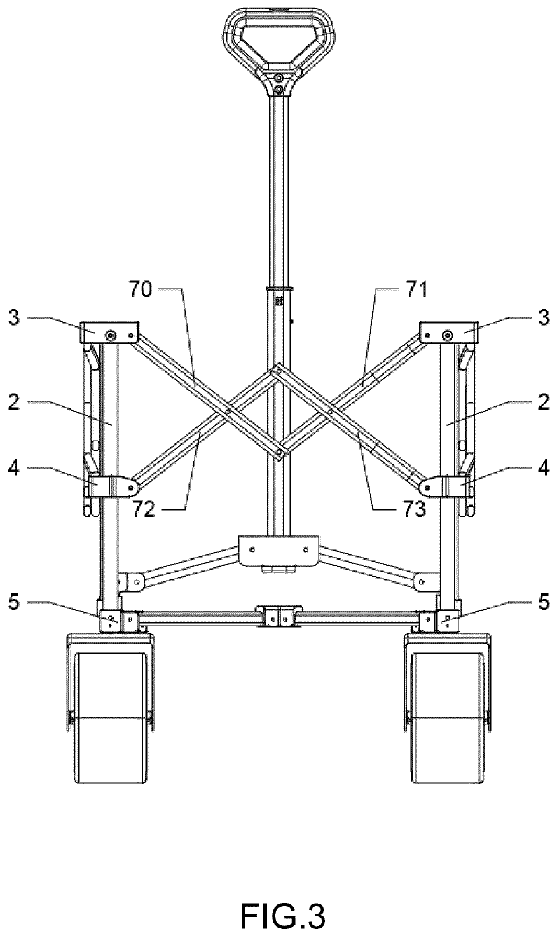

Please refer to FIGS. 1 and 3. Between the two second vertical poles (2), there is a left and right support rod group (7). The left and right support rod group (7) consists of the first left and right support rod (70), the second left and right support rod (71), the third left and right support rod (72), and the fourth left and right support rod (73). Among these, the first left and right support rod (70) is connected inside the upper fixing sleeve (3) at the top of one of the second vertical poles (2). The second left and right support rod (71) is connected inside the upper fixing sleeve (3) at the top of the other second vertical pole (2). The third left and right support rod (72) is connected inside the sliding sleeve (4) in the middle of one of the second vertical poles (2), and the fourth left and right support rod (73) is connected inside the sliding sleeve (4) in the middle of the other second vertical pole (2). The first left and right support rod (70) and the third left and right support rod (72) are set in a cross-configuration, as are the second left and right support rod (71) and the fourth left and right support rod (73). The ends of the first left and right support rod (70) and the second left and right support rod (71), as well as the ends of the third left and right support rod (72) and the fourth left and right support rod (73), are connected to each other.

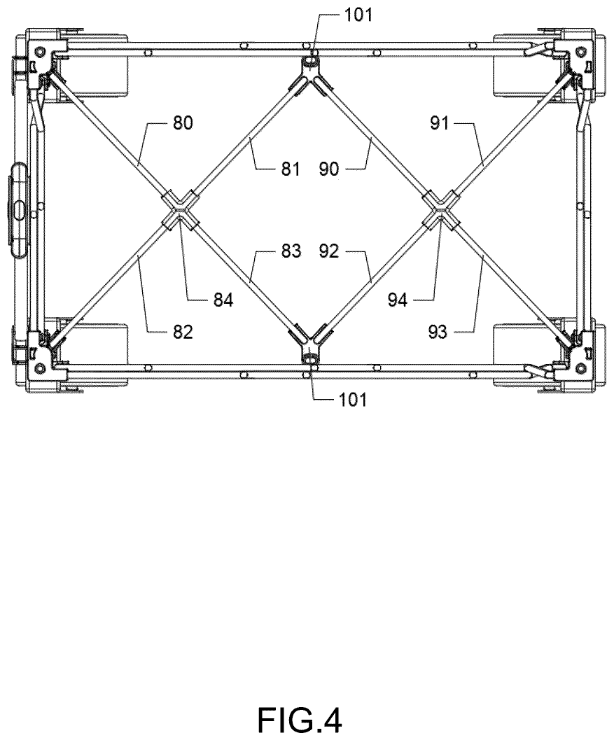

Please refer to FIGS. 1, 2, and 4. Within the plane formed by the four lower fixing sleeves (5), there are a left bottom cross rod group (8) and a right bottom cross rod group (9). At the junction of the second front and rear support rod (61) and the third front and rear support rod (62), and at the intersection of the seventh front and rear support rod (66) and the eighth front and rear support rod (67), there is a hanging rod (10). The bottom of the hanging rod (10) is fixed with a base support piece (101). The left bottom cross rod group (8) consists of a left first bottom cross rod (80), a left second bottom cross rod (81), a left third bottom cross rod (82), and a left fourth bottom cross rod (83). Among these, the left first bottom cross rod (80) is connected inside the upper fixing sleeve (3) at the bottom of one of the first vertical poles (1), and the left third bottom cross rod (82) is connected inside the upper fixing sleeve (3) at the bottom of the other first vertical pole (1). The left second bottom cross rod (81) is connected inside the base support piece (101) on one side, and the left fourth bottom cross rod (83) is connected inside the base support piece (101) on the other side. The left first bottom cross rod (80), left second bottom cross rod (81), left third bottom cross rod (82), and left fourth bottom cross rod (83) converge at the center, and at this convergence point, there is a left center fixing piece (84) that rotates in conjunction with the four cross rods. Similarly, the right bottom cross rod group (9) consists of a right first bottom cross rod (90), a right second bottom cross rod (91), a right third bottom cross rod (92), and a right fourth bottom cross rod (93). Among these, the right second bottom cross rod (91) is connected inside the lower fixing sleeve (5) at the bottom of one of the second vertical poles (2), and the right fourth bottom cross rod (93) is connected inside the lower fixing sleeve (5) at the bottom of the other second vertical pole (2). The right first bottom cross rod (90) is connected inside the base support piece (101) on one side, and the right third bottom cross rod (92) is connected inside the base support piece (101) on the other side. The right first bottom cross rod (90), right second bottom cross rod (91), right third bottom cross rod (92), and right fourth bottom cross rod (93) converge at the center, and at this convergence point, there is a right center fixing piece (94) that rotates in conjunction with the four cross rods.

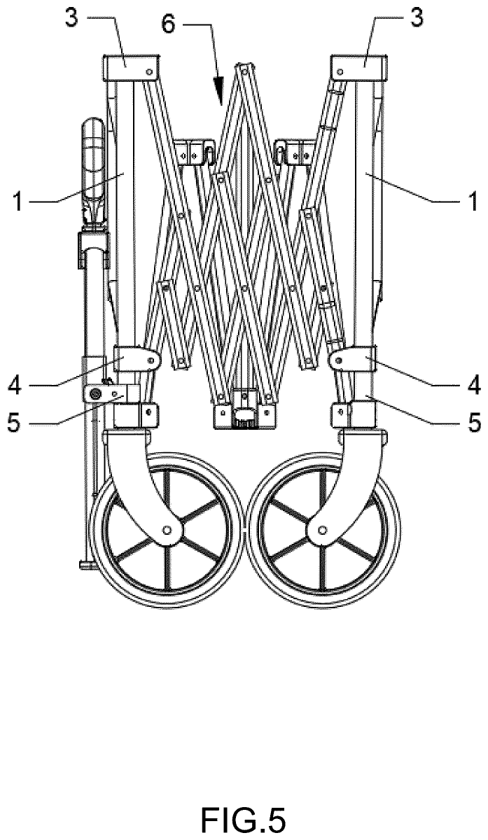

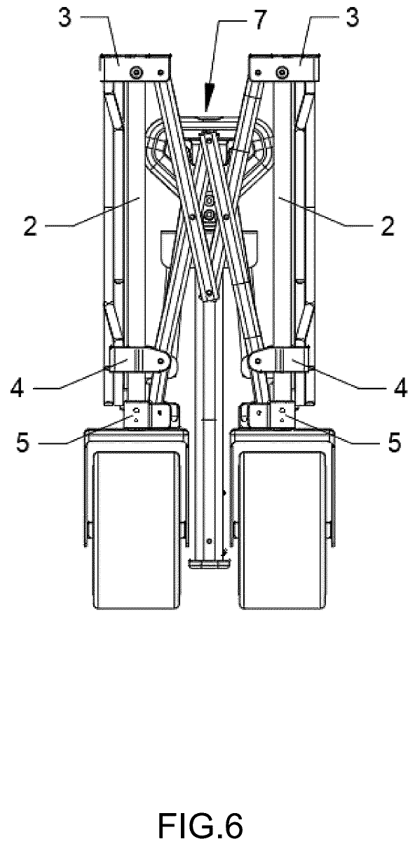

Please refer to FIGS. 5 and 6 for the working principle and usage process of this application. To fold the trailer, firstly, pull up the left center fixing piece (84), causing the left first bottom cross rod (80), left second bottom cross rod (81), left third bottom cross rod (82), and left fourth bottom cross rod (83) to rotate upwards around their central convergence point. Then, pull up the right center fixing piece (94), causing the right first bottom cross rod (90), right second bottom cross rod (91), right third bottom cross rod (92), and right fourth bottom cross rod (93) to rotate upwards around their central convergence point. At this stage, press the first vertical poles (1) and the second vertical poles (2) together, causing the various front and rear support rods in the front and rear support rod group (6) to fold and collapse into each other. Since the position of the hanging rod (10) is fixed, it does not move or rise. Finally, compress both the first vertical poles (1) and the second vertical poles (2) so that each of the left and right support rods in the left and right support rod group (7) fold and collapse into each other, completing the folding process of the trailer.

It should be noted that the descriptions above are only preferred examples of this application and are not intended to limit the scope of this application. Despite detailed descriptions of the application with reference to the aforementioned embodiments, those skilled in the art can still modify the technical solutions described in the various embodiments or equivalently replace some of the technical features. Any modifications, equivalent substitutions, improvements, etc., made within the spirit and principles of this application should be included within the scope of protection of this application.

What is claimed is:

1. A type of bottom double-cross trailer, which includes two first vertical poles and two second vertical poles. The characteristic feature is that there is a set of left and right support rods between the two first vertical poles, and a set of front and rear support rods is situated between the first vertical pole and the second vertical pole. In the middle of the front and rear support rod group is a hanging rod;
On both sides of the hanging rod, there are symmetrically distributed left bottom cross rod groups and right bottom cross rod groups. The left bottom cross rod group is connected to the first vertical pole, and the right bottom cross rod group is connected to the second vertical pole. The bottom of the hanging rod is fixed with a base support piece. The left and right bottom cross rod groups are connected through the hanging rod, and their connection points with the base support piece are designed to rotate.

2. The bottom double cross trailer as claimed in claim 1, characterized in that each of the first vertical pole and the second vertical pole has an upper fixing sleeve and a lower fixing sleeve attached at both the top and bottom, respectively; each of the first vertical pole and the second vertical pole is also equipped with a sliding sleeve that slides up and down along its surface.

3. The bottom double cross trailer as claimed in claim 2, characterized in that the front and rear support rod assembly includes a first front and rear support rod and a fourth front and rear support rod, both pivotally cooperating with the upper fixing sleeve, and a fifth front and rear support rod and a tenth front and rear support rod, both pivotally cooperating with the sliding sleeve.

4. The bottom double-cross trailer as claimed in claim 3, characterized in that the front and rear support rod group further includes a sixth front and rear support rod which rotates in conjunction with the fifth front and rear support rod, a second front and rear support rod rotating in conjunction with the sixth front and rear support rod, a seventh front and rear support rod rotating in conjunction with the first front and rear support rod, a ninth front and rear support rod rotating in conjunction with the tenth front and rear support rod, a third front and rear support rod rotating in conjunction with the ninth front and rear support rod, and an eighth front and rear support rod rotating in conjunction with the fourth front and rear support rod.

5. The bottom double-cross trailer as claimed in claim 4, characterized in that the hanging rod is connected simultaneously at the junctions of the second front and rear support rod and the third front and rear support rod with the junctions of the seventh front and rear support rod and the eighth front and rear support rod.

6. The bottom double-cross trailer as claimed in claim 2, characterized in that the left and right support rod group includes a first left and right support rod and a second left and right support rod, both of which rotate in conjunction with the upper fixing sleeve. The left and right support rod group also includes a third left and right support rod and a fourth left and right support rod, both of which rotate in conjunction with the sliding sleeve. The first left and right support rod and the second left and right support rod rotate in conjunction, as do the third left and right support rod and the fourth left and right support rod.

7. The bottom double-cross trailer as claimed in claim 2, characterized in that the left bottom cross rod group includes a left first bottom cross rod and a left third bottom cross rod, both of which rotate in conjunction with the lower fixing sleeve. The left bottom cross rod group also includes a left second bottom cross rod and a left fourth bottom cross rod, both of which rotate in conjunction with the base support piece. The left first bottom cross rod, left second bottom cross rod, left third bottom cross rod, and left fourth bottom cross rod form an X-shape. The intersection center of the left first bottom cross rod, left second bottom cross rod, left third bottom cross rod, and left fourth bottom cross rod is equipped with a left center fixing piece that rotates in conjunction with them.

8. The bottom double-cross trailer as claimed in claim 2, characterized in that the right bottom cross rod group includes a right second bottom cross rod and a right fourth bottom cross rod, both of which rotate in conjunction with the lower fixing sleeve. The right bottom cross rod group also includes a right first bottom cross rod and a right third bottom cross rod, both of which rotate in conjunction with the base support piece. The intersection center of the right first bottom cross rod, right second bottom cross rod, right third bottom cross rod, and right fourth bottom cross rod is equipped with a right center fixing piece that rotates in conjunction with them.
